(19) United States
(12) Patent Application Publication
(10) Pub. No.: US 2009/0114855 A1
(43) Pub. Date: May 7, 2009

(54) Coil Former

(76) Inventor: Tao Zhang, Cambridgeshire (GB)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/991,433

(22) PCT Filed: Sep. 1, 2006
(86) PCT No.: PCT/GB2006/050268

§ 371 Date: Mar. 3, 2008

(30) Foreign Application Priority Data
Sep. 2, 2005 (GB) 0517859.5

(51) Int. Cl. E02B 5/00; B29C 47/00; B29C 33/38

(52) U.S. Cl. 250/505.1; 425/470; 156/264

(57) ABSTRACT

A coil former (1) comprising a plurality of ceramic plates (2) arranged to form a laminate (3) between first and second ends (4, 5), each plate having an opening therein such that when the plates are arranged in the laminate, a passage (7) is defined between the first and second ends.

### CROSS-REFERENCE TO RELATED APPLICATIONS

The present application is the U.S. National Stage of International Application No. PCT/GB2006/050268 filed Sep. 1, 2006 in English and claiming priority from Great Britain application No. 0517859.5 filed Sep. 2, 2005.

### FIELD OF THE INVENTION

The present invention relates to a coil former.

### BACKGROUND ART

In charged particle beam systems, such as electron-beam lithography systems, coils are used for deflecting and focusing beams of charged particles. The coils are carried on coil formers comprising an electrically insulating material, such as a ceramic or plastics material.

GB-A-2389225 describes a coil former made from a high-strength, non-magnetic and electrically non-conductive ceramic material having a high thermal conductivity and a low coefficient of thermal expansion. However, few ceramics with suitable magnetic, electrical and thermal properties can be used because they cannot be reliably machined into complex shapes without breaking. Suitable ceramics which can be so machined, such as SHAPAL-M (registered trade mark), tend to be expensive. In any case, even if a ceramic can be machined, it is still difficult to machine the ceramic into a complex shape.

The present invention seeks to ameliorate at least some these drawbacks.

### SUMMARY OF THE INVENTION

According to the present invention there is provided a laminated ceramic coil former.

The coil former may comprise a plurality of ceramic plates arranged to form a laminate between first and second ends, each plate having an opening therein such that when the plates are arranged in the laminate, a passage is defined between the first and second ends.

According to the present invention there is also provided a coil former comprising a plurality of ceramic plates arranged to form a laminate between first and second ends, each plate having an opening therein such that when the plates are arranged in the laminate, a passage is defined between the first and second ends.

This can help to simplify manufacture of a coil former since individual ceramic plates can be cut from a sheet of ceramic material. This allows a wider range of ceramic materials to be used.

The ceramic plates may be arranged co-extensively and may comprise flat, annular discs. Each ceramic plate may include at least one pair of slots extending from the opening, such that, when said plates are arranged in the laminate and are rotationally aligned, the laminate defines at least one pair of elongate slots for receiving a coil. The ceramic plates may be identical. The ceramic plates may be held together using heat-resistant glue or using a clamp between the first and second ends. The ceramic plates may comprise aluminium nitride. The ceramic plates may have a thickness between 0.5 mm and 2 mm and may have a diameter of between 10 mm and 50 mm. The coil former may comprise between 10 and 30 plates.

According to the present invention there is further provided a deflector unit for a charged particle beam system comprising a coil former according to any part of the preceding description; and at least one coil wound onto said coil former used as a support. The deflector unit may comprise a pair of coils arranged diametrically opposite one another on either side of the passage.

According to the present invention there is yet further provided a method of fabricating a coil former comprising cutting a plurality of ceramic plates from a sheet of ceramic material, each ceramic plate having an opening and arranging the ceramic plates such that the plurality of ceramic plates form a laminate between first and second ends, and a passage is defined between the first and second ends.

### BRIEF DESCRIPTION OF THE DRAWINGS

An embodiment of the present invention will now be described, by way of example with reference to the accompanying drawings in which:

FIG. 1 is a perspective view of a coil former in accordance with the present invention;

FIG. 2 is a perspective view of a ceramic plate in accordance with the present invention;

FIG. 3 is a plan view of the ceramic plate shown in FIG. 2;

FIG. 4 is an elevation view of the ceramic plate shown in FIG. 2;

FIG. 5 is a perspective view of the coil former shown in FIG. 1 carrying a coil; and

FIG. 6 is a perspective view of a coil shown in FIG. 5.

### DETAILED DESCRIPTION OF EMBODIMENT

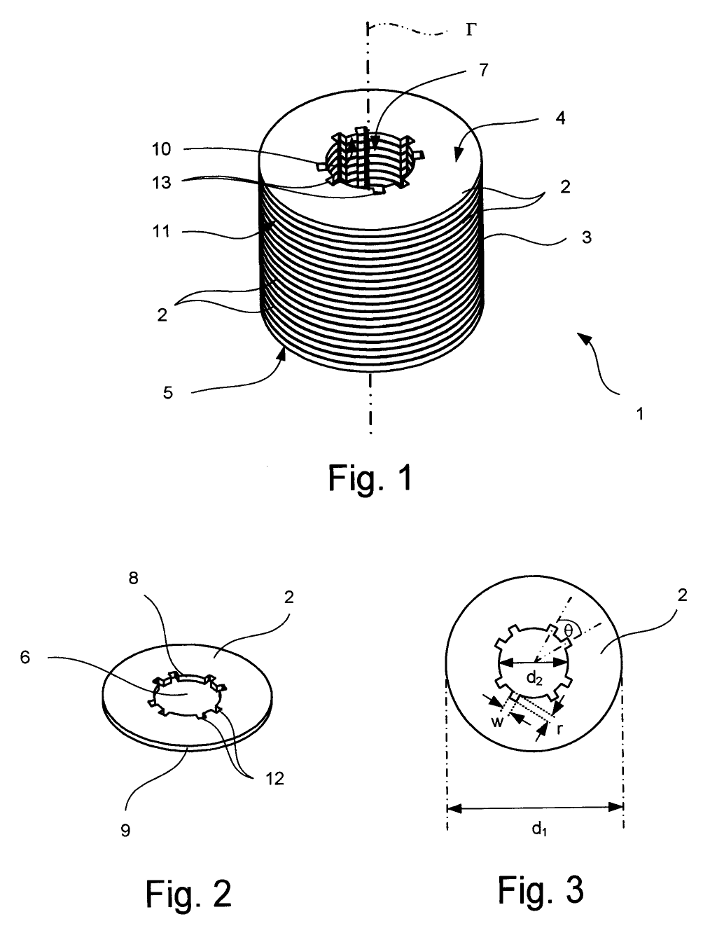

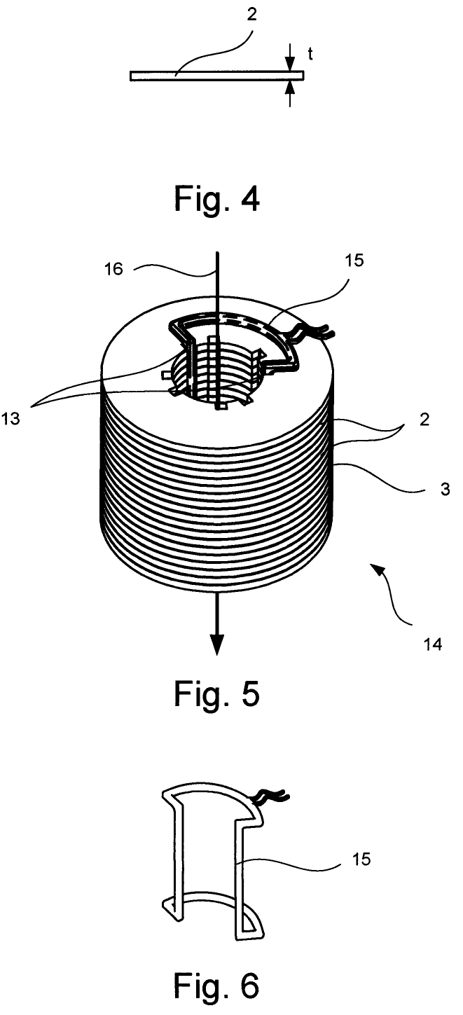

Referring to FIGS. 1 to 4, an embodiment of a coil former 1 according to the present invention comprises a plurality of ceramic plates 2 arranged to form a laminate 3 between first and second ends 4, 5. The ceramic plates 2 generally take the form of flat, annular discs. Each ceramic plate 2 has an opening 6 therein such that when the plates 2 are arranged to form the laminate 3, a passage 7 is defined between the first and second ends 4, 5. The laminate 3 preferably comprises between 10 and 30 ceramic plates 2. The laminate 3 is generally tubular. The laminate 3 may be elongate along an axis r along which plates 2 are arranged.

The ceramic plates 2 are formed from aluminium nitride. However, other non-magnetic and electrically non-conductive ceramic materials may be used, such as boron nitride, silicon carbide and aluminium oxide. As will be explained in more detail later, the ceramic plates 2 can be cut from a sheet of ceramic material, for example by laser cutting. Thus, the ceramic material need not be machinable and so softer ceramic materials can be used.

The ceramic plates 2 are held together using heat-resistant glue, such as cyanoacrylate. Additionally or alternatively, the ceramic plates 2 may be held together using a clamp (not shown).

Each ceramic plate 2 has an inner and outer edge or circumference 8, 9. When the plates 2 are arranged in the support 3, the inner and outer edges 8, 9 define inner and outer walls 10, 11 respectively. The inner wall 10 defines the passage 7. The passage 7 generally has a uniform thickness along its length.

The inner edge 8 of each plate 2 is furnished with at least one pair of radial slots 12. Thus, when the plates 2 are arranged and are rotationally aligned, a set of elongate slots 13 are formed running along the inner wall 10 of the passage 7 between the first and second ends 4, 5 of the laminate 3. Rotational alignment can be achieved by co-extensively superimposing or stacking identical ceramic plates 2.

The ceramic plates 2 are preferably in the form of flat, annular discs having co-axial inner and outer circumferences 8, 9.

The ceramic plates 2 preferably have a diameter, d₁, between 10 and 50 mm and the opening 6 has a diameter, d₂, between 5 and 25 mm. The slots 12 preferably have a radial depth, r, of between 0.5 to 2 mm, a width, w, of between 0.5 to 2 mm and arranged at alternating 30 and 60-degree intervals, θ. The ceramic plates 2 preferably have a thickness, t, between 0.5 and 2 mm. In this example, the ceramic plates 2 each have a thickness of 1 mm.

A method of manufacturing the ceramic plates 2 will now be described:

The plates 2, including the openings 6, are laser cut from a sheet of commercially-available ceramic material (not shown), for example using a Nd:YAG laser, in a manner well known per se.

Low viscosity, heat-resistant glue is applied to an upper surface of a plate 2 and another plate 2 is co-extensively placed on top. Low viscosity glue has an advantage that a uniform thickness of glue can be applied. The plates 2 are stacked ensuring that the slots 12 are arranged in a line parallel with axis Γ (FIG. 1).

Referring to FIGS. 5 and 6, a deflector unit 14 for use in a charged particle beam system (not shown) comprises the coil former 1 (FIG. 1) and at least one coil 15 supported by the coil former 1. For clarity, only one coil 15 is shown. The coil 15 comprises one or more turns of copper wire having an insulating coating. At least part of the coil 15 is carried in a pair of elongate slots 13.

In use, when a current passes through the coil 15, a magnetic field (not shown) is generated which influences a charged particle beam 16 passing through the deflector unit 14. The deflector unit may include at least one pair of coils arranged diametrically opposite one another on either side of the passage.

The deflector unit 14 may be used in an electron beam lithography system, ion-beam implantation system or electron microscope. Further details regarding arrangement and operation of a deflector unit in a charged particle beam system can be found in GB-A-2389225 supra.

It will be appreciated that many modifications may be made to the embodiment hereinbefore described. For example, the ceramic plates need not all be identical. The ceramic plates need not be circular, but can be polygonal. Furthermore, the opening need not be generally circular, but can be polygonal. The plates need not form a closed structure around the aperture.

1. A non-magnetic, laminated ceramic coil former for a deflector unit for deflecting a charged particle beam passing therethrough for use in a charged particle beam system.

2. A coil former according to claim 1, comprising a plurality of ceramic plates arranged to form a laminate between first and second ends, each plate having an opening therein such that when the plates are arranged in the laminate, a passage is defined between the first and second ends.

3. A non-magnetic coil former for a deflector unit for use in a charged particle beam system, the coil former comprising a plurality of ceramic plates arranged to form a laminate between first and second ends, each plate having an opening therein such that when the plates are arranged in the laminate, a passage is defined between the first and second ends.

4. A coil former according to claim 2, wherein the ceramic plates are arranged co-extensively.

5. A coil former according to claim 2, wherein the ceramic plates comprise flat, annular discs.

6. A coil former according to claim 2, wherein each ceramic plate includes at least one pair of slots extending from the opening, such that, when said plates are arranged in the laminate and are rotationally aligned, the laminate defines at least one pair of elongate slots for receiving a coil.

7. A coil former according to claim 2, wherein the ceramic plates are identical.

8. A coil former according to claim 2, wherein the ceramic plates are held together using heat-resistant glue.

9. A coil former according to claim 2, wherein the ceramic plates are held together using a clamp between the first and second ends.

10. A coil former according to claim 2, wherein the ceramic plates comprise aluminium nitride.

11. A coil former according to claim 2, wherein the ceramic plates have a thickness between 0.5 mm and 2 mm.

12. A coil former according to claim 2, wherein the ceramic plates have a diameter of between 10 mm and 50 mm.

13. A coil former according to claim 2, comprising between 10 and 30 plates.

14. A deflector unit for a charged particle beam system comprising:
a coil former according to claim 2; and
at least one coil wound onto said support.

15. A deflector unit according to claim 14, comprising a pair of coils arranged diametrically opposite one another on either side of the passage.

16. A method of fabricating a coil former use in a charged particle beam system comprising:
cutting a plurality of ceramic plates from a sheet of ceramic material, each ceramic plate having an opening; and
arranging the ceramic plates such that the plurality of ceramic plates form a non-magnetic laminate between first and second ends, and a passage is defined between the first and second ends.

17. A coil former according to claim 3, wherein the ceramic plates comprise flat, annular discs.

18. A coil former according to claim 3, wherein each ceramic plate includes at least one pair of slots extending from the opening, such that, when said plates are arranged in the laminate and are rotationally aligned, the laminate defines at least one pair of elongate slots for receiving a coil.

19. A coil former according to claim 3, wherein the ceramic plates are held together using heat-resistant glue.

20. A coil former according to claim 3, wherein the ceramic plates comprise aluminium nitride.
